(19) United States
(12) Patent Application Publication
(10) Pub. No.: US 2018/0195455 A1
(43) Pub. Date: Jul. 12, 2018

(54) ENGINE COMBUSTION PHASING CONTROL DURING TRANSIENT STATE

(71) Applicant: GM GLOBAL TECHNOLOGY OPERATIONS LLC, Detroit, MI (US)

(72) Inventors: Yiran Hu, Shelby Townhip, MI (US); Jun-mo Kang, Ann Arbor, MI (US); Chen-fang Chang, Bloomfield Hills, MI (US); Paul M. Najt, Bloomfield Hills, MI (US)

(73) Assignee: GM GLOBAL TECHNOLOGY OPERATIONS LLC, Detroit, MI (US)

(21) Appl. No.: 15/404,878

(22) Filed: Jan. 12, 2017

(51) Int. Cl. F02D 41/24; F02D 41/26; F02D 41/14; F02P 5/04; F02P 5/15

(52) U.S. Cl. CPC F02D 41/2445; F02D 41/26; F02D 41/2467; F02D 41/2496; F02D 2200/0414; F02P 5/045; F02P 5/15; F02D 2200/021; F02D 2200/1012; F02D 41/1482

(57) ABSTRACT

An engine assembly includes an engine with an engine block having at least one cylinder. A crankshaft is moveable to define a plurality of crank angles from a bore axis defined by the cylinder to a crank axis defined by the crankshaft. The plurality of angles includes a crank angle (CA50) corresponding to 50% of the fuel received by the cylinder being combusted. A controller is operatively connected to the engine and has a processor and a tangible, non-transitory memory on which is recorded instructions for executing a method for controlling the combustion phasing in the engine during a transient state. The controller is programmed to generate a learned table by storing at least one combustion phasing parameter in the tangible, non-transitory memory. Combustion phasing during a transient state is controlled based at least partially on the learned table.

### INTRODUCTION

The disclosure relates generally to control of combustion phasing in an engine during a transient state. The amount of control compensation for optimal combustion phasing varies for different cylinders in a particular engine. Different operating conditions also require varying amounts of control compensation. With rapidly changing torque demand during a transient operation, it is challenging to determine optimal combustion phasing control.

### SUMMARY

An engine assembly includes an engine with an engine block having at least one cylinder and at least one piston movable inside the cylinder. A crankshaft is moveable to define a plurality of crank angles from a bore axis defined by the cylinder to a crank axis defined by the crankshaft. The plurality of crank angles includes a crank angle (CA50) corresponding to 50% of the fuel received by the cylinder being combusted. A controller is operatively connected to the engine and has a processor and a tangible, non-transitory memory on which is recorded instructions for executing a method for controlling the engine during a transient state.

Execution of the instructions by the processor causes the controller to determine if the engine is in a steady state. The controller is programmed to determine if the crank angle (CA50) and a measured air fuel ratio are each sufficiently close to respective predefined targets. If the engine is in the steady state and the crank angle (CA50) and the measured air fuel ratio are both sufficiently close to the respective predefined targets, then the controller is programmed to generate a learned table by storing at least one combustion phasing parameter in the tangible, non-transitory memory. The engine is controlled during the transient state based at least partially on the learned table.

The assembly includes at least one cylinder pressure sensor configured to obtain a pressure reading of the cylinder. The controller includes a closed loop control unit configured to determine an actuator command based at least partially on feedback from the cylinder pressure sensor. Continuous adjustments to the desired combustion phasing may be made through the feedback loop between the cylinder pressure sensor and the closed loop control unit. The transient state is characterized by a rapidly changing torque request made to the controller such that the closed loop control unit is unable to converge to a finite result, i.e., arrive at a finite solution. The closed loop control unit may be a proportional-integral (PI) control unit.

The combustion phasing parameter may include a spark adjustment factor. The spark adjustment factor may be expressed as an adjustment to the spark timing. The spark timing may be expressed in crank degrees before combustion top dead center. The combustion phasing parameter may include an injection timing factor. The injection timing factor may be expressed as an adjustment to the crank angle, relative to TDC of the compression stroke, and represents the time at which injection of fuel begins.

The engine is characterized by an engine speed and an engine load. The combustion phasing parameter is stored at least partially as a function of the engine speed, the engine load and an effective temperature. The effective temperature may be a weighted sum of an engine coolant temperature and an engine intake temperature. Determining if the engine is in a steady state includes determining if the engine speed is within a predefined speed range and the engine load is within a predefined load range, both during a predetermined number of engine events. In one example, the predetermined number of engine events is 20, the predefined speed range is±20 RPM and the predefined load range is between about 1 and 2 milligrams.

At least one actuator is operatively connected to the engine and configured to control at least one of a spark adjustment factor and an injection timing factor. The controller is further programmed to obtain an actuator command for the actuator based at least partially on the learned table and a set of nominal calibrated values. The learned table is configured as a feed-forward term to the set of nominal calibration values during a transient state.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic fragmentary view of an engine assembly;

FIG. 2 is a flowchart for a method of controlling combustion phasing in the engine assembly of FIG. 1;

FIG. 3 is a diagram of a control structure embodying the method of FIG. 2; and

FIG. 4 is a graph showing engine events in the x-axis and engine crank angle in the y-axis.

### DETAILED DESCRIPTION

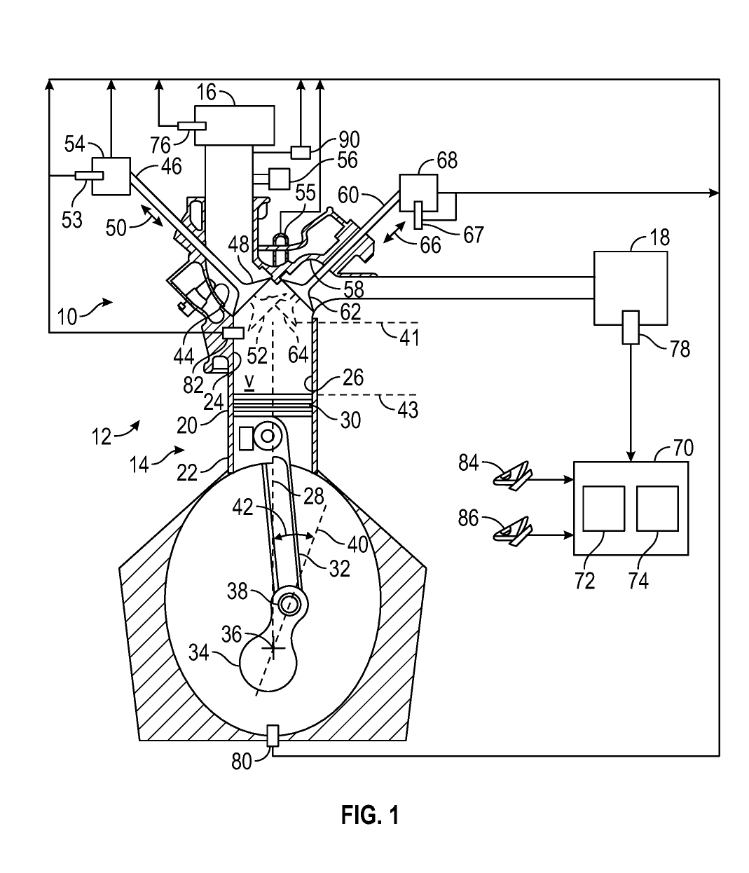

Referring to the drawings, wherein like reference numbers refer to like components, FIG. 1 schematically illustrates a device 10 having an engine assembly 12. The device 10 may be a mobile platform, such as, but not limited to, standard passenger car, sport utility vehicle, light truck, heavy duty vehicle, ATV, minivan, bus, transit vehicle, bicycle, robot, farm implement, sports-related equipment, boat, plane, train or other transportation device. The device 10 may take many different forms and include multiple and/or alternate components and facilities.

The engine assembly 12 includes an internal combustion engine 14, referred to herein as engine 14, for combusting an air-fuel mixture in order to generate output torque. The engine assembly 12 includes an intake manifold 16 in fluid communication with the engine 14. The intake manifold 16 may be configured to receive fresh air from the atmosphere. The intake manifold 16 is fluidly coupled to the engine 14, and capable of directing air into the engine 14. The engine assembly 12 includes an exhaust manifold 18 in fluid communication with the engine 14, and capable of receiving exhaust gases from the engine 14.

Referring to FIG. 1, the engine 14 includes an engine block 20 having at least one cylinder 22. The cylinder 22 has an inner cylinder surface 24 defining a cylinder bore 26. The cylinder bore 26 extends along a bore axis 28. The bore axis 28 extends along a center of the cylinder bore 26. A piston 30 is positioned inside the cylinder 22. The piston 30 is configured to move or reciprocate inside the cylinder 22 along the bore axis 28 during the engine cycle.

The engine 14 includes a rod 32 pivotally connected to the piston 30. Due to the pivotal connection between rod 32 and the piston 30, the orientation of the rod 32 relative to the bore axis 28 changes as the piston 30 moves along the bore axis 28. The rod 32 is pivotally coupled to a crankshaft 34. Accordingly, the movement of the rod 32 (which is caused by the movement of the piston 30) causes the crankshaft 34 to rotate about its center 36. A fastener 38, such as a pin, movably couples the rod 32 to the crankshaft 34. The crankshaft 34 defines a crank axis 40 extending between the center 36 of the crankshaft 34 and the fastener 38.

Referring to FIG. 1, a crank angle 42 is defined from the bore axis 28 to the crank axis 40. As the piston 30 reciprocates along the bore axis 28, the crank angle 42 changes due to the rotation of the crankshaft 34 about its center 36. Accordingly, the position of the piston 30 in the cylinder 22 can be expressed in terms of the crank angle 42. The piston 30 can move within the cylinder 22 between a top dead center (TDC) position (i.e., when the top of the piston 30 is at the line 41) and a bottom dead center (BDC) position (i.e., when the top of the piston 30 is at the line 43). The TDC position refers to the position where the piston 30 is farthest from the crankshaft 34, whereas the BDC position refers to the position where the piston 30 is closest to the crankshaft 34. When the piston 30 is in the TDC position (see line 41), the crank angle 42 may be zero (0) degrees. When the piston 30 is in the BDC position (see line 43), the crank angle 42 may be one hundred eighty (180) degrees.

The desired combustion phasing may be characterized by the crank angle 42 corresponding to 50% of the fuel received by the cylinder 22 being combusted, referred to hereinafter as “CA50,” with the piston 30 being after a top-dead-center (TDC) position. Referring to FIG. 1, the engine 14 includes at least one intake port 44 in fluid communication with both the intake manifold 16 and the cylinder 22. The intake port 44 allows gases, such as air, to flow from the intake manifold 16 into the cylinder bore 26. The engine 14 includes at least one intake valve 46 capable of controlling the flow of gases between the intake manifold 16 and the cylinder 22. Each intake valve 46 is partially disposed in the intake port 44 and can move relative to the intake port 44 between a closed position 48 and an open position 52 (shown in phantom) along the direction indicated by double arrows 50. When the intake valve 46 is in the open position 52, gas, such as air, can flow from the intake manifold 16 to the cylinder 22 through the intake port 44. When the intake valve 46 is in the closed position 48, gases, such as air, are precluded from flowing between the intake manifold 16 and the cylinder 22 through the intake port 44. A first cam phaser 54 may control the movement of the intake valve 46.

Referring to FIG. 1, the engine 14 may receive pressurized fuel from a fuel injector 56. In response to a fuel command (FC) from the controller 70, the fuel injector 56 is configured to inject a mass of fuel at a specific time. The fuel injector 56 may be employed through any location in the engine 14, e.g., port fuel injection and direct injection.

Referring to FIG. 1, the at least one cylinder 22 is operatively connected to a spark plug 55. In response to a spark command (SC) from the controller 70, the spark plug 55 is configured to produce an electric spark in order to ignite the compressed air-fuel mixture in the cylinder 22 at a specific time. It is to be understood that the engine 14 may include multiple cylinders with corresponding spark plugs.

As noted above, the engine 14 can combust an air-fuel mixture, producing exhaust gases. The engine 14 further includes at least one exhaust port 58 in fluid communication with the exhaust manifold 18. The exhaust port 58 is also in fluid communication with the cylinder 22 and fluidly interconnects the exhaust manifold 18 and the cylinder 22. Thus, exhaust gases can flow from the cylinder 22 to the exhaust manifold 18 through the exhaust port 58.

The engine 14 further includes at least one exhaust valve 60 capable of controlling the flow of exhaust gases between the cylinder 22 and the exhaust manifold 18. Each exhaust valve 60 is partially disposed in the exhaust port 58 and can move relative to the exhaust port 58 between closed position 62 and an open position 64 (shown in phantom) along the direction indicated by double arrows 66. When the exhaust valve 60 is in the open position 64, exhaust gases can flow from the cylinder 22 to the exhaust manifold 18 through the exhaust port 58. When the exhaust valve 60 is in the closed position 62, exhaust gases are precluded from flowing between the cylinder 22 and the exhaust manifold 18 through the exhaust port 58. A second cam phaser 68 may control the movement of the exhaust valve 60. Furthermore, the second cam phaser 68 may operate independently of the first cam phaser 54.

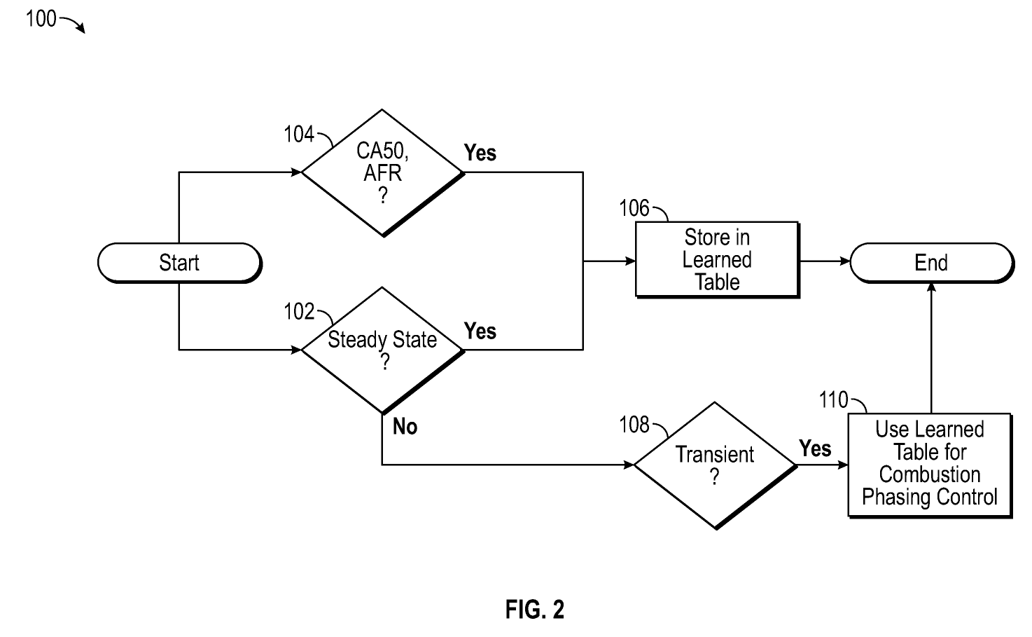

Referring to FIG. 1, the engine assembly 12 includes a controller 70 operatively connected to or in electronic communication with the engine 14. Referring to FIG. 1, the controller 70 includes at least one processor 72 and at least one memory 74 (or any non-transitory, tangible computer readable storage medium) on which are recorded instructions for executing method 100 for controlling combustion phasing in the engine 14 during a transient state, shown in FIG. 2, and described below. The memory 74 can store controller-executable instruction sets, and the processor 72 can execute the controller-executable instruction sets stored in the memory 74.

The controller 70 of FIG. 1 is specifically programmed to execute the steps of the method 100 and can receive inputs from various sensors. The engine assembly 12 may include an intake temperature sensor 76 capable of measuring intake temperature and in communication (e.g., electronic communication) with the controller 70, as shown in FIG. 1. A wide range AFR sensor 78 is in communication with the controller 70 and the exhaust manifold 18, as shown in FIG. 1. The controller 70 may obtain an air fuel ratio (AFR) based on the input signals from the wide range AFR sensor 78.

Additionally, the parameters may be obtained via “virtual sensing”, such as for example, modeling based on other measurements. For example, the intake temperature may be virtually sensed based on a measurement of ambient temperature. The controller 70 may be programmed to determine the AFR based on other methods or sensors, without the wide range AFR sensor 78. The controller 70 is in communication with the first and second cam phasers 54, 68 and can therefore control the operation of the intake and exhaust valves 46, 60. The controller 70 is also in communication with first and second position sensors 53, 67 that are configured to monitor positions of the first and second cam phasers 54, 68, respectively.

Referring to FIG. 1, a crank sensor 80 is operative to monitor crankshaft rotational position, i.e., crank angle and speed. A cylinder pressure sensor 82 may be employed to obtain the in-cylinder combustion pressure of the at least one cylinder 22. The cylinder pressure sensor 82 may be monitored by the controller 70 to determine a net-effective-pressure (NMEP) for each cylinder 22 for each combustion cycle. The controller 70 may be operatively connected to a coolant temperature sensor 90.

The controller 70 is programmed to receive a torque request from an operator input or an auto start condition or other source monitored by the controller 70. The controller 70 is configured to receive input signals from an operator, such as through an accelerator pedal 84 and brake pedal 86, to determine the torque request. The method 100 may be employed for controlling combustion phasing in the engine 14 during a transient state. A transient state may occur during a sudden change in the torque request, for example, when an operator tips into the accelerator pedal 84 requesting an immediate increase in torque, and thus an increase in injected fuel mass. The torque required for acceptable drivability will push the shaping of an immediate torque faster than the system can react.

The method 100 may be applied when the assembly 12 is in a low temperature combustion mode. Low temperature combustion (LTC) refers to advanced combustion strategies that leverage lower combustion temperature to reduce NOx and/or soot formation. An example of a low temperature combustion mode is homogeneous charge compression ignition (HCCI) mode (such as, for example, in negative valve overlap (NVO) and positive valve overlap (PVO) cases), understood by those skilled in the art. Here, the term “negative valve overlap” refers to engine operation in which the intake valve 20 starts to open after the exhaust valve 60 has closed during a cylinder event. The term “positive valve overlap” refers to engine operation in which the intake valve 46 starts to open before the exhaust valve 60 has closed during a cylinder event.

Referring now to FIG. 2, a flowchart of the method 100 stored on and executable by the controller C of FIG. 1 is shown. The method 100 need not be applied in the specific order recited herein. Furthermore, it is to be understood that some steps may be eliminated. Referring to FIG. 2, method 100 may begin with block 102, where the controller 70 is programmed or configured to determine if the engine 14 is in a steady state. Determining if the engine 14 is in a steady state may include determining if an engine speed, obtained via an engine speed sensor, is within a predefined speed range during a predetermined number of engine events. Determining if the engine 14 is in a steady state may include determining if an engine load is within a predefined load range during a predetermined number of engine events. In one example, the predetermined number of engine events is 20, the predefined speed range is±20 RPM, and the predefined load range is between about 1 and 2 milligrams of fuel. In other words, a steady state is defined as a sufficiently small variation in engine speed, engine load and other factors, for a sufficient amount of time.

In block 104 of FIG. 2, the controller 70 is programmed to determine if the crank angle (CA50) at 50% of the fuel being combusted (measured via crank sensor 80) and an air fuel ratio (AFR) are each sufficiently close to respective predefined targets. As noted above, the air fuel ratio (AFR) may be derived via the wide range AFR sensor 78. The amount of air and fuel delivered to an engine 14 may be closely controlled such that an air-fuel ratio (AFR) approximates an ideal ratio or stoichiometric AFR. In one example, the stoichiometric AFR is 14.7:1 for a gasoline engine, meaning that each pound of gasoline injected into the cylinder 22 results in the combustion of 14.7 pounds of air. It is to be appreciated that the desired AFR is not required to be the same as the stoichiometric AFR, and the combustion modes may run at an AFR leaner than stoichiometric.

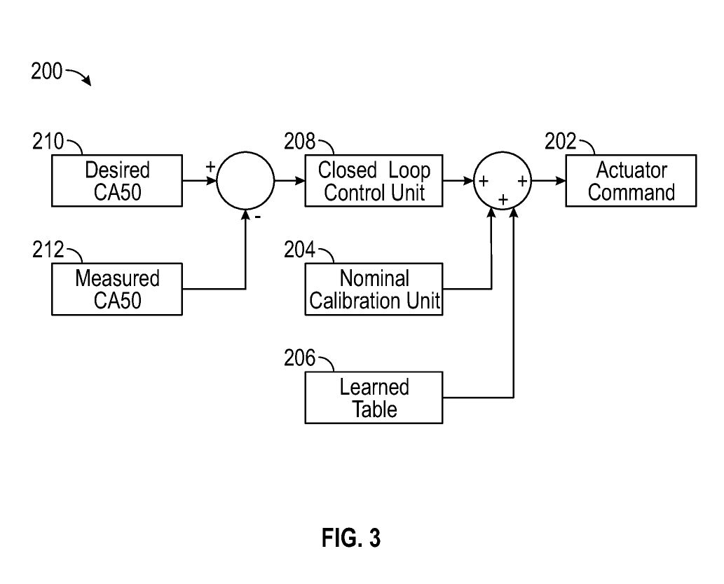

If the engine 14 is in the steady state and the crank angle (CA50) and the air fuel ratio (AFR) are both sufficiently close to their respective predefined targets (e.g. within±5%), then the method 100 proceeds to block 106. In block 106 of FIG.2, the controller 70 is programmed to generate a learned table (see 206 in FIG. 3) by storing at least one combustion phasing parameter in the tangible, non-transitory memory 74.

The combustion phasing parameter may be stored at least partially as a function of the engine speed, the engine load and an effective temperature. The effective temperature may be an average temperature representing in-cylinder conditions. The effective temperature may be a weighted sum of an engine coolant temperature (obtained via coolant temperature sensor 90) and an engine intake temperature (obtained via intake temperature sensor 76 operatively connected to the intake manifold 16). A non-limiting example of a portion of a learned table is shown in Table 1. When using the learned table, when the operating condition falls in-between the grid points, an interpolation method may be used to interpolate the table values. Any interpolation method known to those skilled in the art may be employed, including but not limited to, simple linear approximation, a polynomial curve-fit or other curve-fitting method.

TABLE 1

| Engine Speed | | Effective | | |
|---|---|---|---|---|
| (RPM) | Load | Temperature | ΔSA | ΔIT |
| S1 | L1 | T1 | +5 | +8 |
| S2 | L1 | T1 | +4 | +6 |
| S1 | L2 | T1 | −2 | −5 |
| S1 | L1 | T2 | −3 | −4 |

The learned table incorporates the spark and injection timing factor adjustments during steady state operation so that effective combustion phasing control can be achieved during a transient state. The combustion phasing parameter may include a spark adjustment factor (ASA), given in crank angle degrees before combustion top dead center (TDC). The spark adjustment may be defined as an adjustment to the crank angle 42 such that a spark will occur. In one example, the spark adjustment factor (ASA) ranges from+5 crank angle degrees. The combustion phasing parameter may include an injection timing factor (AIT), given in crank angle degrees before top dead center (TDC). The injection timing factor may be defined as an adjustment to the crank angle 42 for one or both of the beginning of fuel injection or the end of fuel injection. In one example, the injection timing factor (AIT) ranges from±10 crank angle degrees.

If the engine 14 is not in a steady state per block 102, the method 100 may proceed to block 108. In block 108, the controller 70 may be programmed to determine if the engine 14 is in a transient state, for example, by determining if a predefined time period has elapsed. In another example, the controller 70 may be programmed to set up a flag to indicate whether the calculations in a closed loop control unit 208 (shown in FIG. 3) have converged, e.g., the flag may be set as TRUE for convergence and FALSE for non-convergence. As noted above, a transient state may occur during a sudden change in the torque request, for example, when an operator tips into the accelerator pedal 84 requesting an immediate increase in torque, and thus an increase in injected fuel mass. If the engine 14 is determined to be in a transient state, the method 100 proceeds to block 110, where the controller 70 is programmed to employ the Learned Table stored in the memory 74 for combustion phasing control. Alternatively, the method 100 may proceed directly to block 110 from block 102.

Referring to FIG. 3, an example control structure 200 embodying the method 100 is shown. The control structure 200 results in the generation of at least one actuator command 202 during a transient state. The actuator command 202 may be a fuel command (FC) for injection of a mass of fuel at a specific time, as described above. The actuator command 202 may be a spark command (SC) for producing a spark at a specific time, as described above. The control structure 200 employs at least three inputs that are added together to determine the actuator command 202. Referring to FIG. 3, the three inputs are: nominal calibration unit 204, the learned table 206 and the closed loop control unit 208.

Referring to FIG. 3, the controller 70 is programmed to obtain a set of nominal calibrated values for a desired combustion phasing, via the nominal calibration unit 204. The nominal calibration values (for spark and injection timing factor) may be obtained via the methods generally employed by those skilled in the art. For example, the nominal calibration values may be obtained via design-of-experiment (DOE), statistical or optimization methods or a model-based calibration process. The nominal calibration values may be obtained via an experimental set-up in a laboratory. The learned table 206 may be configured as a feed-forward term to the nominal calibration unit 204 during a transient state. Feed forward is generally understood as the modification or control of a process using its anticipated results or effects. The learned table 206 is obtained from the method 100, described above.

As noted above, the desired combustion phasing may be specified by the desired crank angle (CA50) at which 50% of the total heat release has occurred. Due to cylinder to cylinder variations, the output of the nominal calibration unit 204 need to be modified by the closed loop control unit 208 to achieve the desired crank angle (CA50) for each cylinder 22. The amount of adjustment required varies between multiple cylinders and operating conditions.

The closed loop control unit 208 forces the crank angle (CA50) to converge to a desired solution in steady state, in other words, it cannot work instantaneously. The controller 70 does not have time to fully adjust during a transient state, resulting in sub-optimal tracking. The method 100 is configured to opportunistically learn optimal spark adjustment and injection timing factors when the closed loop control unit 208 achieves desired crank angle (CA50) during steady state and apply the learning during a transient state. The transient state is characterized by a rapidly changing torque request made to the controller 70 such that the closed loop control unit 208 is unable to converge to a finite solution. The learned table 206 acts as a correction factor for obtaining optimal combustion phasing.

Referring to FIG. 3, the closed loop control unit 208 is configured to receive feedback from the cylinder pressure sensor 82, depicted in FIG. 3 as block 212 or “Measured CA50”. The closed loop control unit 208 may be a proportional-integral (PI) control unit configured to continuously calculate an error value as the difference between a desired set-point (block 210 or “Desired CA50”) and a measured process variable (block 212 or “Measured CA50”). The closed loop control unit 208 is configured to apply a correction based on proportional and integral terms, i.e. accounting for present and past values of the error, and minimize the error over time. For example, if the error is large and positive, the correction will also be large and positive.

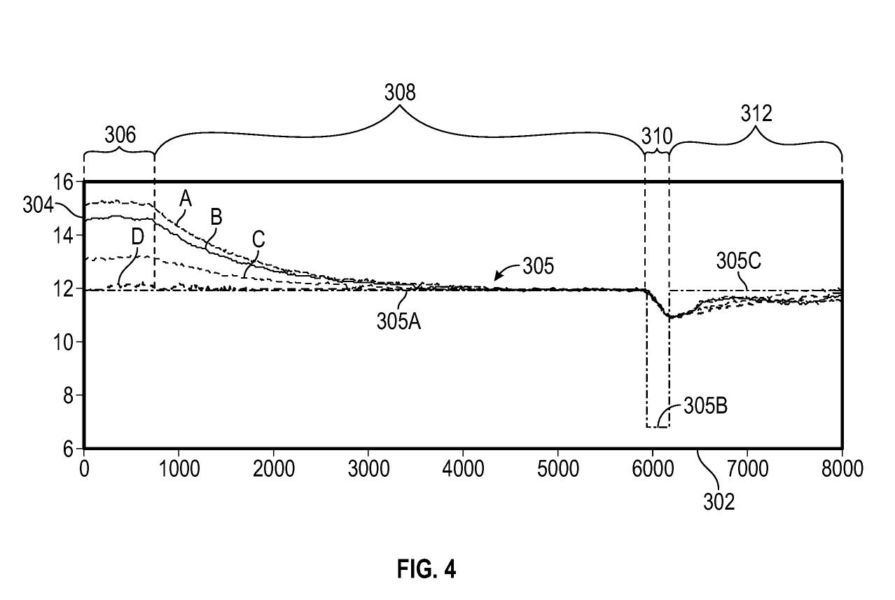

Referring to FIG. 4, a graph is shown with time or events in the horizontal axis 302 and crank angle, in degrees after TDC, in the vertical axis 304. Traces A, B, C and D show respective measured crank angles (CA50), at which 50% fuel is combusted, for four separate cylinders in an engine. The trace 305 tracks the desired crank angle (CA50).

Referring to FIG. 4, a first period 306 illustrates the respective crank angles (CA50) without the closed loop control unit 208 or the learned table 206. In the first period 306, the traces A, B, C and D vary for each of the cylinders and are not controlled to the desired crank angle (CA50). Referring to FIG. 4, a second period 308 illustrates respective crank angles (CA50) with both the closed loop control unit 208 and the learned table 206 turned on. In the second period 308, the traces A, B, C and D gradually converge to the desired crank angle (CA50), reflected by trace 305A.

Referring to FIG. 4, a third period 310 illustrates a shifting or changeover event such that the desired CA50 experiences a significant shift (see trace 305B). A fourth period 312 illustrates the respective measured crank angle (CA50) with the learned table 206 turned on and the closed loop control unit 208 turned off. In the fourth period 312, the traces A, B, C and D gradually converge to the desired crank angle (CA50) (see trace 305C), showing that the respective crank angles (CA50) of the four cylinders may be successfully controlled in the absence of the input of the closed loop control unit 208 and with the input from the learned table 206.

In summary, a learned table is developed to opportunistically learn optimal spark and late injection timing factor for different operating conditions during a low temperature combustion mode (e.g. NVO, PVO) combustion operation. This method allows the optimal timing to be used where a closed loop control unit 208 does not have an opportunity to converge and allows for better combustion phasing control across all cylinders in an engine 14 during a transient state. Improved combustion phasing control during transient conditions improves combustion efficiency and reduces combustion noise. The method 100 of FIG. 2 may be employed in an engine 14 having spark-ignition mode. In spark-ignition engines, the mass of fuel to inject in the cylinder 22 is tied to airflow. When torque demand changes faster than airflow, the desired combustion phasing may be used to meet the torque demand.

The method 100 may be employed in conjunction with closed loop control of CA50 in a low temperature combustion mode to reduce combustion phasing error during a transient state. The method 100 (and the controller 70 executing the method 100) improves the functioning of the device by enabling control of torque output of a complex engine system with a minimum amount of error. Thus the method 100 (and the controller 70 executing the method 100) are not mere abstract ideas, but are intrinsically tied to the functioning of the device 10 and the (physical) output of the engine 14. The method 100 may be executed continuously during engine operation as an open loop operation.

The method 100 assumes instantaneous combustion in a constant-volume model such that cylinder pressure instantaneously equilibrates with external pressure (such as intake or exhaust manifold pressure) once the intake valve 46 or exhaust valve 60 opens. The controller 70 of FIG. 1 may be an integral portion of, or a separate module operatively connected to, other controllers of the device 10, such as the engine controller.

The controller 70 includes a computer-readable medium (also referred to as a processor-readable medium), including any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which may constitute a main memory. Such instructions may be transmitted by one or more transmission media, including coaxial cables, copper wire and fiber optics, including the wires that comprise a system bus coupled to a processor of a computer. Some forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Look-up tables, databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store may be included within a computing device employing a computer operating system such as one of those mentioned above, and may be accessed via a network in any one or more of a variety of manners. A file system may be accessible from a computer operating system, and may include files stored in various formats. An RDBMS may employ the Structured Query Language (SQL) in addition to a language for creating, storing, editing, and executing stored procedures, such as the PL/SQL language mentioned above.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

What is claimed is:

1. An engine assembly comprising:
an engine including an engine block having at least one cylinder defining a bore axis and at least one piston movable in the at least one cylinder;
wherein the at least one cylinder is configured to receive a fuel;
wherein the engine includes a crankshaft defining a crank axis, the crankshaft being moveable to define a plurality of crank angles from the bore axis to the crank axis;
wherein the plurality of angles includes a crank angle (CA50) corresponding to 50% of the fuel received by the at least one cylinder being combusted;
a controller operatively connected to the engine and having a processor and a tangible, non-transitory memory on which is recorded instructions for executing a method for controlling combustion phasing during a transient state;
wherein execution of the instructions by the processor causes the controller to:
determine if the engine is in a steady state;
determine if the crank angle (CA50) and a measured air fuel ratio are each sufficiently close to respective predefined targets;
if the engine is in the steady state and the crank angle (CA50) and the measured air fuel ratio are both sufficiently close to the respective predefined targets, then generate a learned table by storing at least one combustion phasing parameter in the tangible, non-transitory memory; and
control the engine during the transient state based at least partially on the learned table.

2. The assembly of claim 1, wherein the at least one combustion phasing parameter includes a spark adjustment factor.

3. The assembly of claim 1, wherein the at least one combustion phasing parameter includes an injection timing factor.

4. The assembly of claim 1, further comprising:
at least one cylinder pressure sensor configured to obtain a pressure reading of the at least one cylinder;
wherein the controller includes a closed loop control unit configured to determine an actuator command based at least partially on feedback received from the at least one cylinder pressure sensor; and
wherein the transient state is characterized by a rapidly changing torque request made to the controller such that the closed loop control unit is unable to converge to a finite result.

5. The assembly of claim 4, wherein the closed loop control unit is a proportional-integral (PI) control unit.

6. The assembly of claim 1, wherein:
the engine is characterized by an engine speed and an engine load;
the at least one combustion phasing parameter is stored at least partially as a function of the engine speed, the engine load and an effective temperature; and
the effective temperature is a weighted sum of an engine coolant temperature and an engine intake temperature.

7. The assembly of claim 1, wherein said determining if the engine is in the steady state includes:
determining if an engine speed is within a predefined speed range during a predetermined number of engine events; and
determining if an engine load is within a predefined load range during the predetermined number of engine events.

8. The assembly of claim 5, wherein:
the predetermined number of engine events is 20;
the predefined speed range is±20 RPM; and
the predefined load range is between about 1 and 2 milligrams.

9. The assembly of claim 1, further comprising:
at least one actuator operatively connected to the engine and configured to control at last one of a spark adjustment factor and an injection timing factor;
wherein the controller is further programmed to obtain an actuator command for the at least one actuator based at least partially on the learned table and a set of nominal calibrated values.

10. A method of controlling an engine assembly during a transient state, the engine assembly including a controller, an engine having an engine block with at least one cylinder defining a bore axis and configured to receive a fuel, a crankshaft defining a crank axis, the crankshaft being moveable to define a plurality of crank angles from the bore axis to the crank axis, the method comprising:
determining if the engine is in a steady state, via the controller;
determining a crank angle (CA50) for the at least one cylinder, via the crank sensor, the crank angle (CA50) corresponding to 50% of the fuel received by the at least one cylinder being combusted;
determining if the crank angle (CA50) and a measured air fuel ratio are each sufficiently close to respective predefined targets;
if the engine is in the steady state and the crank angle (CA50) and the measured air fuel ratio are both sufficiently close to the respective predefined targets, then generating a learned table by storing at least one combustion phasing parameter in the tangible, non-transitory memory, via the controller; and
controlling a combustion phasing of the at least one cylinder during the transient state based at least partially on the learned table.

11. The method of claim 10, wherein the at least one combustion phasing parameter includes at least one of a spark adjustment factor and an injection timing factor.

12. The method of claim 10, wherein:
the engine is characterized by an engine speed and an engine load; and
the at least one combustion phasing parameter is stored at least partially as a function of the engine speed, the engine load and an effective temperature.

13. The method of claim 10, wherein said determining if the engine is in the steady state includes:
determining if an engine speed is within a predefined speed range during a predetermined number of engine events; and
determining if an engine load is within a predefined load range during the predetermined number of engine events.

14. The method of claim 10, further comprising:
operatively connecting at least one actuator to the engine, the at least one actuator configured to control at least one of a spark adjustment factor and an injection timing factor;
obtain an actuator command for the at least one actuator based at least partially on the learned table and a set of nominal calibrated values.

15. The method of claim 10, further comprising:
obtain a pressure reading of the at least one cylinder via at least one cylinder pressure sensor operatively connected to the engine;
operatively connecting at least one actuator to the engine, the at least one actuator being configured to control at least one of a spark adjustment factor and an injection timing factor;
wherein the controller includes a closed loop control unit configured to obtain an actuator command for the at least one actuator based at least partially on feedback from the at least one cylinder pressure sensor; and
wherein the transient state is characterized by a rapidly changing torque request made to the controller such that the closed loop control unit is unable to converge to a finite result.
